(19) United States
(12) Patent Application Publication
(10) Pub. No.: US 2025/0340674 A1
(43) Pub. Date: Nov. 6, 2025

(54) METHOD FOR PREPARING MODIFIED CARBOXYMETHYL CHITOSAN

(71) Applicant: Shandong University, Jinan (CN)

(72) Inventors: Zhaojie CUI, Jinan (CN); Xiaowei CUI, Jinan (CN); Xingxu YU, Jinan (CN); Huitian DUAN, Jinan (CN); Shuo LI, Jinan (CN); Rui ZHAO, Jinan (CN); Tao LI, Jinan (CN); Kang WANG, Jinan (CN)

(73) Assignee: Shandong University, Jinan (CN)

(21) Appl. No.: 19/074,511

(22) Filed: Mar. 10, 2025

(30) Foreign Application Priority Data
May 6, 2024 (CN) 202410547820.6

(51) Int. Cl. C08B 37/08

(52) U.S. Cl. CPC C08B 37/003

(57) ABSTRACT

Provided is a method for preparing a modified carboxymethyl chitosan, including the following steps: (1), weighing and adding a quality of chitosan to isopropanol (IA), subjecting a resulting mixture to swelling by stirring at room temperature for a period of time to obtain a swollen suspension; (2), subjecting the swollen suspension to alkalization at room temperature by adding a 40% NaOH solution to the swollen suspension; (3), heating a resulting alkalinized mixture by raising a temperature of a water bath to 60° C., and then slowly adding dropwise an isopropanol-chloroacetic acid (IA-MCA) mixture using a separatory funnel, subjecting an obtained mixture to reaction; and after the reaction is completed, adjusting a pH value of an obtained reaction product to about 7.0 using glacial acetic acid.

### CROSS REFERENCE TO RELATED APPLICATION

This patent application claims the benefit and priority of Chinese Patent Application No. 202410547820.6 filed with the China National Intellectual Property Administration on May 6, 2024, the disclosure of which is incorporated by reference herein in its entirety as part of the present application.

### TECHNICAL FIELD

The present disclosure relates to the technical field of biochemistry, in particular to a method for preparing a modified carboxymethyl chitosan.

### BACKGROUND

Chitosan has excellent hydroscopicity, moisture retention, film forming and biocompatibility. It has been widely used in food, medicine, cosmetics and environmental protection. However, the poor water solubility of the chitosan limits its further application. There are various methods for modifying chitosan, and there are many factors that affect the preparation of modified chitosan. The ratio of raw materials and reaction time could have a significant impact on the carboxymethylation of chitosan. However, there is little research on the optimal ratio and reaction time of each material so far. Therefore, the degree of substitution of modified materials prepared by general experimental methods is not high, usually only reaching about 0.5, with poor water solubility. Thus, the carboxymethyl chitosan prepared by existing experimental methods has low degree of substitution, poor flowability, and poor water solubility.

### SUMMARY

Based on the technical problems existing in the background, the present disclosure provides a method for preparing a modified carboxymethyl chitosan.

To achieve the above object, the present disclosure adopts the following technical solution:

Provided is a method for preparing the modified carboxymethyl chitosan, including the following steps:
step 1, weighing and adding a quality of chitosan to isopropanol (IA), subjecting a resulting mixture to swelling by stirring at room temperature for a period of time to obtain a swollen suspension;
step 2, subjecting the swollen suspension to alkalization at room temperature by adding a 40% NaOH solution to the swollen suspension;
step 3, heating a resulting alkalinized mixture by raising a temperature of a water bath to 60° C., and then slowly adding dropwise an isopropanol-chloroacetic acid (IA-MCA) mixture using a separatory funnel, subjecting an obtained mixture to reaction; and after the reaction is completed, adjusting a pH value of an obtained reaction product to about 7.0 using glacial acetic acid; and
step 4, adding a distilled water to fully dissolve the obtained reaction product, and centrifuging to remove an insoluble matter to obtain a supernatant, precipitating by adding absolute ethanol to the supernatant to obtain a precipitate, washing the precipitate three times with methanol, and drying an obtained solid to constant weight in a vacuum drying oven at 65° C. to obtain N,O-carboxymethyl chitosan (N,O-CMS).

In some embodiments, in step 1, a mass ratio of the NaOH to the chitosan is 6:8, a mass ratio of chloroacetic acid (MCA) to the chitosan is 4:5, and the IA has a volume of 100 mL to 120 mL.

In some embodiments, the reaction in step 3 lasts for 4 h to 5 h.

In some embodiments, in step 1, the chitosan has a weight of 5 g, 55 mL of an isopropanol solution is used as a swelling liquid, and the swelling lasts for 2 h.

In some embodiments, the 40% NaOH solution in step 2 is formulated with 35 g of a sodium hydroxide solid.

In some embodiments, the IA-MCA mixture in step 3 is 55 mL of a chloroacetic acid-isopropanol solution, and the chloroacetic acid has a weight of 22.5 g.

In some embodiments, the swelling liquid in step 1 is 60 mL of an isopropanol solution, and the 40% NaOH solution in step 2 is formulated with 30 g of a sodium hydroxide solid, and the reaction in step 3 is conducted for 4.5 h.

In some embodiments, the reaction in step 3 may further last for 5 h.

Compared with the prior art, the embodiments of the present disclosure have the following beneficial effects:

The present disclosure designs a four-factor three-level orthogonal table, optimizes reaction conditions with a degree of substitution as an index, and determines optimal preparation conditions of modified chitosan. A natural polymer material prepared by modification is environmentally friendly and pollution-free, and could be applied in a plurality of fields. A proportion is optimized by single factor experiment and orthogonal experiment to find optimal reaction time, improving a degree of substitution by carboxymethyl, increasing water solubility, increasing water solubility, and solving problems of poor water solubility and limited application of general chitosan.

### DETAILED DESCRIPTION OF THE EMBODIMENTS

To make the object, technical solution, and beneficial effects of the present disclosure clearer, the present disclosure will be further described below with reference to the examples. It should be understood that the specific examples described herein are merely intended to explain the present disclosure but not to limit the present disclosure.

### Example 1

A method for preparing a modified carboxymethyl chitosan was performed by the following steps:
step 1, 5 g of chitosan was added to 55 mL of an isopropanol solution and fully swelled for 2 h, and a 40% sodium hydroxide solution was added thereto to fully alkalize at room temperature for 2 h (35 g of sodium hydroxide solid was formulated into a 40% solution).
step 2, 55 mL of chloroacetic acid-isopropanol solution was added to a resulting alkalized solution, and a resulting system was subjected to reaction at 60° C. for 4 h (the weight of chloroacetic acid was 22.5 g).
step 3, after the reaction was completed, the pH value of an obtained reaction product was adjusted to about 7 using glacial acetic acid. Distilled water was added to fully dissolve the obtained reaction product. A resulting material was subjected to suction filtration to collect a supernatant, and precipitation was conducted by adding absolute ethanol thereto to obtain a precipitate. The precipitate was fully washed three times with methanol, and the solid was dried to constant weight in a vacuum drying oven at 65° C. to yield N,O-carboxymethyl chitosan (N,O-CMS).

In this method, a mass ratio of the NaOH, the MCA and the chitosan was 7:4.5:1, the volume of IA was 110 mL, the reaction was conducted for 4 h, and the degree of substitution of the prepared N,O-CMS is 1.350.

### Example 2

A method for preparing a modified carboxymethyl chitosan, was performed by the following steps:
step 1, 5 g of chitosan was added to 60 mL of an isopropanol solution and fully swelled for 2 h, and a 40% sodium hydroxide solution was added thereto to fully alkalize at room temperature for 2 h (30 g of sodium hydroxide solid was formulated into a 40% solution).
step 2, 60 mL of chloroacetic acid-isopropanol solution was added to a resulting alkalized solution, and a resulting system was subjected to reaction at 60° C. for 4.5 h (the weight of chloroacetic acid was 22.5 g).
step 3, after the reaction was completed, the pH value of an obtained reaction solution was adjusted to about 7 using glacial acetic acid. Distilled water was added to fully dissolve the obtained reaction product. A resulting material was subjected to suction filtration to collect a supernatant and precipitation was conducted by adding absolute ethanol thereto to obtain a precipitate. The precipitate was fully washed three times with methanol, and the solid was dried to constant weight in a vacuum drying oven at 65° C. to yield N,O-CMS.

In this method, a mass ratio of the NaOH, the MCA and the chitosan was 6:4.5:1, the volume of IA was 120 mL, the reaction was conducted for was 4.5 h, and the degree of substitution of the prepared N,O-CMS is 1.274.

### Example 3

A method for preparing a modified carboxymethyl chitosan, was performed by the following steps:
step 1, 5 g of chitosan was added to 60 mL of an isopropanol solution and fully swelled for 2 h, and a 40% sodium hydroxide solution was added thereto to fully alkalize at room temperature for 2 h (30 g of sodium hydroxide solid was formulated into a 40% solution);
step 2, 60 mL of chloroacetic acid-isopropanol solution was added to a resulting alkalized solution, and a resulting system was subjected to reaction at 60° C. for 5 h (the weight of chloroacetic acid was 22.5 g).
step 3, after the reaction was completed, the pH value of an obtained reaction solution was adjusted to about 7 using glacial acetic acid. Distilled water was added to fully dissolve the obtained reaction product. A resulting material was subjected to suction filtration to collect a supernatant and precipitation was conducted by adding absolute ethanol thereto to obtain a precipitate. The precipitate was fully washed three times with methanol, and the solid was dried to constant weight in a vacuum drying oven at 65° C. to yield N,O-CMS.

In this method, a mass ratio of the NaOH, the MCA and the chitosan was 7:4:1, the volume of IA was 120 mL, the reaction was conducted for 5 h, and the degree of substitution of the prepared N,O-CMS is 1.312.

The foregoing are merely descriptions of preferred specific embodiments of the present disclosure, but the scope of the present disclosure is not limited thereto. Any equivalent replacement or modification made within a technical scope of the present disclosure by a person skilled in the art according to the technical solutions of the present disclosure and inventive concepts thereof shall fall within the scope of the present disclosure.

What is claimed is:

1. A method for preparing a modified carboxymethyl chitosan, comprising the following steps:
step 1, weighing and adding chitosan to isopropanol (IA), subjecting a resulting mixture to swelling by stirring at room temperature to obtain a swollen suspension;
step 2, subjecting the swollen suspension to alkalization at room temperature by adding a 40% NaOH solution to the swollen suspension;
step 3, heating a resulting alkalinized mixture by raising a temperature of a water bath to 60° C., and then adding dropwise an isopropanol-chloroacetic acid (IA-MCA) mixture using a separatory funnel, subjecting an obtained mixture to reaction; and after the reaction is completed, adjusting a pH value of an obtained reaction product to 7.0 using glacial acetic acid; and
step 4, adding a distilled water to fully dissolve the obtained reaction product, and centrifuging to remove an insoluble matter to obtain a supernatant, precipitating by adding absolute ethanol to the supernatant to obtain a precipitate, washing the precipitate three times with methanol, and drying an obtained solid to constant weight in a vacuum drying oven at 65° C. to obtain N,O-carboxymethyl chitosan (N,O-CMS).

2. The method for preparing the modified carboxymethyl chitosan of claim 1, wherein a mass ratio of NaOH to the chitosan is 6:8, a mass ratio of chloroacetic acid (MCA) to the chitosan is 4:
5, and the IA has a volume of 100 mL to 120 mL.

3. The method for preparing the modified carboxymethyl chitosan of claim 1, wherein the reaction in step 3 is conducted for 4 h to 5 h.

4. The method for preparing the modified carboxymethyl chitosan of claim 1, wherein in step 1, the chitosan has a weight of 5 g;
55 mL of an isopropanol solution is used as a liquid for the swelling; and
the swelling is conducted for 2 h.

5. The method for preparing the modified carboxymethyl chitosan of claim 1, wherein the 40% NaOH solution in step 2 is formulated with 35 g of a sodium hydroxide solid.

6. The method for preparing the modified carboxymethyl chitosan of claim 1, wherein the IA-MCA mixture in step 3 is 55 mL of an isopropanol-chloroacetic acid solution, with a weight of chloroacetic acid in the isopropanol-chloroacetic acid solution being 22.5 g.

7. The method for preparing the modified carboxymethyl chitosan of claim 1, wherein a liquid for the swelling in step 1 is 60 mL of an isopropanol solution;
the 40% NaOH solution in step 2 is formulated with 30 g of a sodium hydroxide solid; and
the reaction in step 3 is conducted for 4.5 h.

8. The method for preparing the modified carboxymethyl chitosan of claim 1, wherein the reaction in step 3 is conducted for 5 h.
